(19) United States
(12) Patent Application Publication
(10) Pub. No.: US 2022/0046975 A1
(43) Pub. Date: Feb. 17, 2022

(54) EDIBLE FOOD CONTAINERS AND METHOD FOR MAKING THE SAME

(71) Applicant: GABRIEL SKULEC, Newberg, OR (US)

(72) Inventor: GABRIEL SKULEC, Newberg, OR (US)

(21) Appl. No.: 17/402,967

(22) Filed: Aug. 16, 2021

Related U.S. Application Data
(60) Provisional application No. 63/066,049, filed on Aug. 14, 2020.

(51) Int. Cl. A23P 30/10; B65D 65/46; A23L 19/00; A23L 25/00; A23B 7/02

(52) U.S. Cl. CPC A23P 30/10; B65D 65/463; A23B 7/02; A23L 25/30; A23L 19/09

(57) ABSTRACT

Embodiments include edible containers and an example method for making the edible containers. In one possible embodiment, a mixture of seeds, vegetables, fruits, spices, and water is blended to create a paste. The paste is then deposited onto a mold of the desired container shape, and smoothed to a consistent thickness. The mold and paste are then dehydrated, and the container separated from the mold. The container is then dehydrated further to a desired moisture content. The process may be automated by using a rotating table with the mold, and an automatic dispenser.

### TECHNICAL FIELD

Disclosed embodiments are generally related to food containers. Specifically, edible food containers and methods for making the same are disclosed.

### BACKGROUND

When taking food on the go, using disposable containers, e.g. plates, bowls, cups, and flatware, is often preferable to durable containers. Durable containers, typically made of relatively thick, rigid materials such as plastic, metal, or glass, are often heavier than their disposable counterparts, as they are intended to be repeatedly washed and reused. Conversely, disposable containers, as the name suggests, are typically intended to be used only once, then discarded appropriately. Disposable containers are usually lighter in weight, as they do not need to withstand the rigors of repeated washing. Choosing disposable containers for take-out meals thus provides the convenience of lighter weight, and not needing to retain and transport the empty food containers following use for subsequent washing.

The background description provided herein is for the purpose of generally presenting the context of the disclosure. Unless otherwise indicated herein, the materials described in this section are not prior art to the claims in this application and are not admitted to be prior art by inclusion in this section.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts an example edible cup and example edible bowl, according to various embodiments.

FIG. 2 depicts the components of an example system for producing the example edible cup or bowl of FIG. 1, according to various embodiments.

FIG. 3 is a cross-sectional view of the silicone mold depicted in FIG. 2, illustrating the positioning of a paste used to create an edible container, according to various embodiments.

FIG. 4 is a second cross-sectional view of the silicone mold in FIG. 2, illustrating an even layer of the paste following smoothing to the mold, according to various embodiments.

FIG. 5 depicts a process flow for a method of making an edible food container such as the example edible cup or bowl of FIG. 1, according to various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Disposable food containers may come in a variety of shapes, depending upon their intended usage. Some containers are used primarily for storage, such as “clamshell” style containers, while other types may be intended more for eating, e.g. plates, bowls, and cups, as well as utensils such as forks, spoons, and knives. Such disposable containers and utensils may be constructed from a variety of materials

Disclosed embodiments include disposable and edible food containers that provide a natural, nutritious and hand-held alternative to conventional disposable food containers that are made from plastic, Styrofoam, or plastic lined paper. All these conventional materials are not biodegradable and are harmful to the environment as unwanted waste.

Embodiments of the disclosed edible containers can be used to serve low, medium and high viscosity cold, warm or hot liquids, pureed or blended food. A good example would be a pureed soup. The disclosed edible containers may hold cold, warm or hot liquids for extended periods of time without losing structural integrity.

The disclosed edible containers can replace a serving dish that is usually made from plastic, Styrofoam, plastic lined paper, ceramic, glass, metal or wood. The containers have a cracker-like substance and may be consumed along with the contained drink or food, eliminating waste of disposable food containers and also saving the energy used for dishwashing of conventional dishes and utensils. The disclosed containers thus offer the convenience of, for example, sipping your soup as you walk, similar to eating ice cream or drinking your coffee on-the-go.

Food containers made according to the disclosed embodiments can provide a healthier and environmentally friendly solution for restaurants and food vendors who could use the edible containers to serve different kinds of grab-n-go drinks or food in them.

FIG. 1 depicts two possible examples of an edible container, an edible bowl 100 and edible cup 150, according to some embodiments that may result from the method disclosed herein. The example bowl and cup each include a consistent thickness of its walls that contribute to the container rigidity and allow only gradual rehydration over a prolonged period of time. Using a no-bake process, such as will be described below as one potential embodiment, helps provide a healthier, more nutritious product because of the raw plant-based ingredients and dehydration process used, as opposed to cooking, baking or frying. Other edible containers that currently exist are made from baked dough, wafer style material providing a lower nutritious value.

As can be seen from FIG. 1, edible containers may be formed into a variety of sizes and shapes to accommodate various types of food and/or liquids, such as bowls, plates, and cups of varying sizes. The shape and thickness of a given container may be tailored to meet the requirements of a given type of food or drink. The example production process disclosed below facilitates the raw, plant based, whole food ingredients retaining all their inherent vitamins, minerals and enzymes, providing a healthier option over existing containers that may use a baked dough. In the disclosed method, the temperature used to dehydrate the containers is held between 100 F and 115 F to preserve most of the nutrients that are in the raw plant-based material. This preservation may improve the appeal of the disclosed containers for people who prefer a raw, whole food diet. The final product, made from raw and plant-based ingredients, is gluten free and vegan friendly.

In FIG. 2, an example embodiment of a system 200 for making an edible container, such as edible bowl 100 or edible cup 150, is depicted. System 200 includes a silicone mold 202, upon which an edible container is formed into a desired shape. Silicone mold 202 is disposed upon a rotating table 204 which spins the silicone mold 202 to assist in formation of the edible container. The silicone mold 202 is fed while rotating from a dispenser 206 which contains a paste that will form the edible container. Paste in the dispenser 206 is dispensed for formation upon silicone mold 202 by action of a piston 208.

Rotating table 204 may be configured to accept a variety of shapes and sizes of silicone mold 202. As depicted in FIG. 2, silicone mold 202 is typically mounted inverted upon the rotating table 204, to facilitate formation of the bottoms of bowl and cup-shaped edible containers. Rotating table 204 may be rotated by a motor or other suitable mechanism. In some embodiments, the speed at which rotating table 204 rotates may be automatically coordinated with the speed at which a paste to form the edible container is dispensed or applied upon the silicone mold 202. In other embodiments, the rotational speed of rotating table 204 may be manually controlled by a user. In still other embodiments, a stationary table may be employed instead of a rotating table 204, with the mechanism for depositing the paste rotated around the stationary table. Rotating table 204 may, in some embodiments, rise or lower as it rotates, to allow a bead of paste to be progressively deposited upon the mold 202, such as where hose 210 (discussed below) is in a fixed or rigid position. Further, rotating table 204 may be able to move laterally as well as vertically, to keep the hose 210 a consistent distance from the surface of mold 202, and to allow deposition of paste onto a relatively flat top surface of mold 202 in forming the bottom of an edible container.

Dispenser 206 may be any food-safe container that is sized to hold a quantity of paste sufficient to create an edible container. In some embodiments, such as a production line, dispenser 206 may hold a sufficient quantity of paste to create a relatively large batch of edible containers. As depicted in FIG. 2, a single dispenser 206 may feed a single silicone mold 202 and rotating table 204. In other implementations, a single dispenser 206 may supply multiple molds 202, and may be equipped with multiple hoses 210, with a hose 210 each dedicated to a separate mold 202.

Piston 208 may be configured or actuated to dispense the paste onto silicone mold 202 at a controlled speed that is tied to the rotational speed of rotating table 204. The controlled speed may further be dependent upon the desired thickness of the edible container, and/or the consistency of the paste. Piston 208 may be actuated by a solenoid, or another suitable mechanism such as a screw or worm drive. In some implementations, piston 208 may be coupled to rotating table 204 via a control unit or sensors, so that piston 208 is configured to cause paste to be dispensed at a rate appropriate to the rotational speed of rotating table 204, or, in embodiments that employ a stationary table, the speed at which hose 210 is rotated about mold 202. For example, as rotating table 204 increases in rotational speed, piston 208 may be actuated at a greater rate to impose a greater pressure upon the paste within dispenser 206, so that the paste is dispensed at a greater rate. In still other embodiments, the speed of piston 208 may be manually controlled and/or piston 208 may be manually actuated to provide a user with control over the speed at which the paste is dispensed.

In the depicted embodiment, the paste is delivered from dispenser 206 by a hose 210. The hose 210 may be equipped with a nozzle positioned proximate to silicone mold 202 such that the paste is applied and sticks 212 to the mold 202, thereby forming the edible container. The nozzle may be configured to dispense a bead of paste in an appropriate shape and size to optimize formation of the edible container. Further, the nozzle and/or hose 210 may be secured to an actuator (not shown) configured to move the hose 210 relative to the silicone mold 202 while the rotating table 204 is rotating and paste is being dispensed via piston 208 from dispenser 206, in embodiments where rotating table 204 is not configured to move vertically or horizontally. Thus, as the hose 210 is moved, either by an actuator or manually by an operator, relative to the moving mold 202, the edible container is formed to a desired thickness as the paste sticks 212. As mentioned above, in other embodiments that employ a stationary table, hose 210 may be free to move or rotate about the silicone mold 202.

Hose 210 may be manufactured from any suitable food-safe material. Hose 210 may be manufactured from flexible material, or may be implemented using rigid piping and/or channels, or a combination of any of the foregoing. In embodiments that employ automated manufacture, hose 210 may be secured rigidly proximate to the mold 202, at a fixed distance from mold 202. Depending upon the specifics of a given implementation, hose 210 may be user-adjustable to be set to an appropriate distance from mold 202 to achieve formation of the edible container to a desired thickness. In some embodiments, hose 210 may be capable of horizontal motion, but not vertical motion; rotating table 204 may move vertically while hose 210 moves horizontally in some such embodiments. In still other embodiments, hose 210 may be flexible and unattached, to allow a user to manually manipulate the hose 210 to dispense paste upon the mold 202 by hand.

In FIG. 3, the silicone mold 202 is illustrated in cross-section with a layer of paste 302 deposited upon its outer surface. Thus, FIG. 3 illustrates an edible container at an intermediate step in formation, such as after deposition of the paste 302 upon the mold 202 while rotating, depicted in FIG. 2, has completed. As can be seen, paste 302 is deposited to an approximately consistent thickness. However, depending upon the shape of the nozzle attached to hose 210, the outer surface of the paste 302 may be deposited with a ridged or textured pattern, such as if the bead of paste from the nozzle is round. Furthermore, a round or similarly shaped bead may also cause cavities to remain between the paste 302 and the silicone mold 202. A smoothing tool 304 may be employed following deposition of the paste 302 when the textured pattern is not desired, to yield a smooth surface and consistent thickness to paste 302. Smoothing tool 304 may deploy automatically following deposition of the entire layer of paste 302, or may be employed progressively as the paste 302 is deposited.

Smoothing tool 304 may be a spatula, scraper, or similar bladed implement, and may be constructed of a suitable material such as rubber, plastic, or metal. In some embodiments, smoothing tool 304 may be fixedly mounted proximate to mold 202, to help ensure a consistent thickness to paste 302. Smoothing tool 304 may be attached to a moving mechanism in other embodiments to cause it to move as the paste 302 is deposited. In yet other embodiments, smoothing tool 304 may be hand held by a user, who may manually smooth the paste 302.

As can be seen in FIG. 3, the mold 202 is essentially an inverted silicone cup. The use of silicone can help assist in removal of the edible container once formed, as silicone naturally resists sticking to food. Furthermore, silicone is typically soft and flexible, and so can deform to help remove the edible container without breakage. However, mold 202 may be manufactured from other food same materials, such as metal or plastic, depending upon the needs of a given implementation. For example, mold 202 may be manufactured from metal where the mold 202 will apply heat in the process of making an edible container. In some embodiments, rotating table 204 may be configured to accept a variety of different sizes and shapes of mold 202, to allow system 200 to be used to manufacture a variety of different shapes and/or sizes of edible containers.

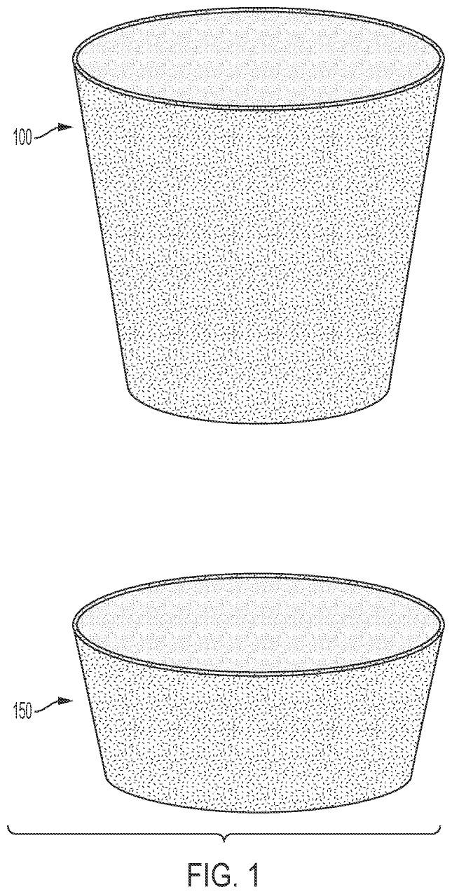

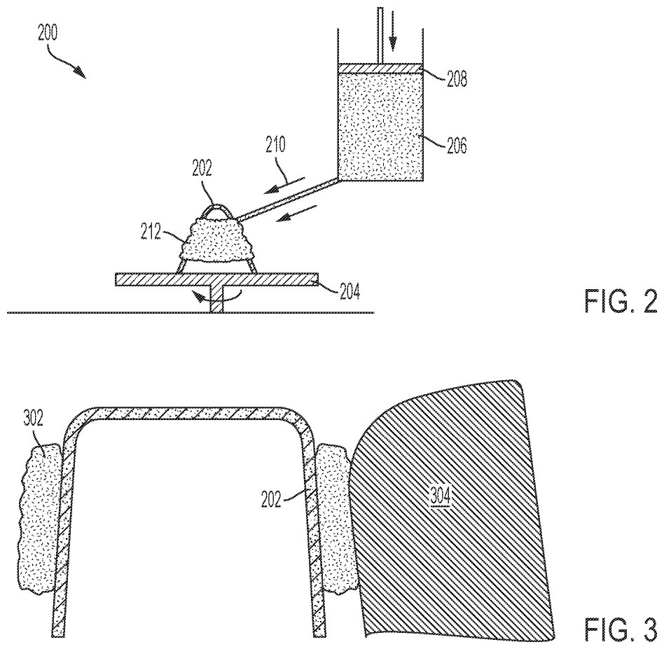

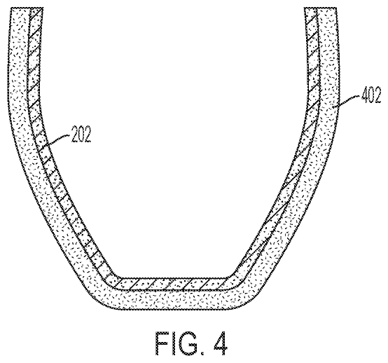

In FIG. 4, a completed edible container 402 is illustrated, with a consistent thickness of paste, formed around silicone mold 202. As will be understood, mold 202 is depicted upright, removed from rotating table 204. In some embodiments, mold 202 may be removed from rotating table 204 following completion of formation, with the edible container 402 still attached. Once removed, the silicone mold 202 may be flexed gently to remove the edible container 402. In other embodiments, e.g. where system 200 is automated, silicone mold 202 may be deflated following formation to cause the edible container 402 to release from the mold 202.

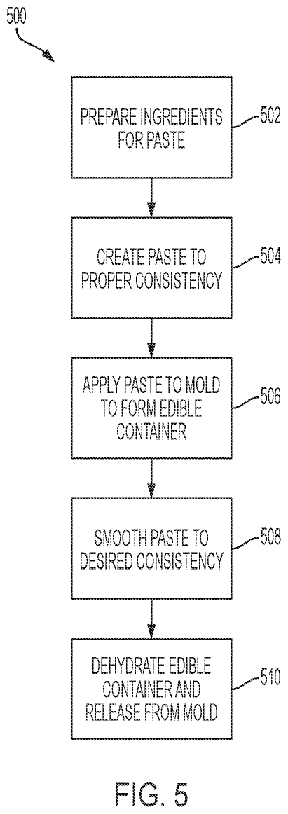

Turning to FIG. 5, an example method 500 for making an edible container according to a possible embodiment is described. The operations of method 500 may be performed in the depicted order or, if the operations so permit, out of order. In other embodiments, one or more operations may be omitted and/or additional operations may be added or modified. Method 500 may be used with an automated system, such as system 200.

In operation 502, the ingredients to create the paste for an edible container are prepared. In one possible embodiment, operation 502 consists of preparing the following ingredients in the following fashion: Soak 120 g of flax seeds in 400 ml of lukewarm water and 55 g of raw sunflower seeds in 60 ml of lukewarm water for 24 hours. Coarsely chop 50 g of celery stalk, 50 g of carrots, 5 g garlic, 150 g of red tomatoes, and 40 g 50 g of red bell pepper. For seasonings use 1 teaspoon of salt and 1 teaspoon of pepper.

The primary ingredient for creating the paste mixture are the soaked seeds that are blended to a jelly-like consistency. Achieving this consistency, in the example method, is key as the blended vegetables that are added later also contain liquid in the form of juice. If the seeds are not blended properly the mixture will not have the desired viscosity, and may be too runny. Furthermore, the vegetable ingredients and seasonings can be chosen based on desired taste and color for the final product. The foregoing list of ingredients and their specified quantities should be understood as only one possible example.

In operation 504, the paste is created from the prepared ingredients in operation 502. In one possible embodiment, the paste is created as follows: When the seeds are soaked, drain any excess water. With blender on low blend the soaked seeds with 2 tablespoon of gluten free soy sauce until a jelly-like consistency is obtained. Transfer the paste into a mixing bowl. Using a food processor chop all the vegetables until a pureed consistency is achieved. Add the pureed vegetables to the paste in the mixing bowl and stir together. Keep stirring while gradually adding 20 g of powdered flex seeds, 20 g of ground carraway seeds, 50 g of ground oats and 25 g of whole grain rolled oats to achieve the right paste viscosity—not too runny. It should be understood that this is one possible way of preparing the paste. Commercial production may follow a similar process, but scaled up and using commercial-grade equipment. Varying degrees of automation may be employed.

In operation 506, the paste is applied to a mold, such as silicone mold 202. When prepared by hand, the paste may be applied to mold 202 as follows: Based on 8 oz serving of soup transfer 160 g of the paste onto the surface of a 16 oz cup shaped mold made from silicone, a non-stick material. A simple device, such as a cake icing plastic bag outfitted with a metal tip, can be used. For automated production, a system 200 for transferring the paste onto the mold surface, shown in FIG. 2, can be employed. The reader is referred to the foregoing description of system 200 in connection with FIG. 2 for an understanding of an automated production process.

In operation 508, the paste is smoothed to achieve a consistent thickness for the edible container. For example, using a rubber spatula, the paste is spread evenly on the mold surface to create a consistent wall of at least 4 mm for containers used for serving hot drinks or pureed soup, as shown in FIG. 3 and FIG. 4. The wall thickness can be 2 mm for containers used for serving less liquid options, like bowls or trays. Other types of edible containers may require differing wall thicknesses. Some types of edible containers may have a wall thickness that varies across different parts, e.g. the base of the container may be relatively thick, while the rim of the container may be relatively thin.

In other embodiments, the paste may be applied to the mold using different techniques or equipment, such as 3D printing or a comparable selective deposition technology, or spraying. The use of different techniques may reduce or eliminate the need for smoothing as part of operation 508, where the application technique results in an acceptably smooth and consistent paste layer. Further, the use of selective deposition or spraying may facilitate edible containers that may have a variable thickness paste layer, e.g. a first part of the container, such as the base, is of a first thickness, and a second part of the container, such as the rim or lip, is of a second thickness that is thinner than the first thickness. The thickness may transition between thick and thin gradually, or at a defined point, e.g. the base is a first thickness, and the sides and rim are a second thickness. Still other edible containers may have three or more different thicknesses, depending upon the needs of a given container.

In operation 510, the formed edible container is then dried. In one possible embodiment, the container is dried as follows: Put the mold into dehydrator and dehydrate for 24 hours. The best option is to use dehydrators with temperature control that allows you to limit the temperature to the 100 F-115 F. Remove the mold from the dehydrator and carefully separate the edible container from the mold, place the edible container back into the dehydrator, and dehydrate at the same temperature for an additional 3 hours. Finally, remove the dehydrated containers from the dehydrator; inspect them for dryness and add more time to dehydrate if necessary. It should be understood that the temperature range of 100 F-115 F is selected based upon the ingredients used to form the paste, and, as mentioned above with respect to FIG. 1, to help preserve the nutrients found in the ingredients. Different temperatures may be employed where the paste is made from different ingredients, or where preservation of nutrients is not a significant concern.

It will be understood that, where a rotating or stationary table is employed, operation 510 will require removal of the mold 202 from the table. In some implementations, this may accomplished manually. Other embodiments may use a commercial-grade dehydrator or automated dehydrating machinery, and all or part of the table with the mold still attached may be passed through the machinery automatically. For example some embodiments may employ infra-red dehydrators. Still other embodiments may forego a dehydrator and instead employ a freeze drying process, or may employ a freeze drying process in conjunction with dehydration. In still other embodiments, the mold 202 may facilitate drying by supplying heat, and/or by allowing air (heated or otherwise) to reach the edible container to facilitate drying. Still further, machinery may be utilized to automatically remove the edible container from the mold 202 when it is sufficiently dry. Dryness may be monitored by one or more sensors to determine when a given edible container or batch of edible containers has been properly dehydrated. Such sensed information may be fed to a control unit which dynamically adjusts the dehydrating times, temperatures, and/or other relevant parameters to ensure that each edible container is appropriately dried to a desired or appropriate moisture level or moisture content.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for making an edible container, comprising:
preparing a paste from a mixture of vegetable materials;
depositing a quantity of the paste onto a mold to form the edible container;
smoothing the paste on the mold to a consistent thickness;
partially dehydrating the edible container upon the mold;
releasing the edible container from the mold; and
further dehydrating the edible container to a desired moisture content.

2. The method of claim 1, wherein the vegetable materials comprise a mixture of seeds, vegetables, fruits, spices, and water.

3. The method of claim 2, wherein the mixture of seeds, vegetables, fruits, spices, and water comprises one or more of flax seeds, sunflower seeds, celery, carrots, garlic, red tomatoes, red bell peppers, salt, and pepper.

4. The method of claim 1, further comprising:
placing the mold onto a rotating table; and
placing the paste into a dispenser;
wherein depositing the quantity of paste onto the mold comprises depositing, from the dispenser, the paste onto the mold while the mold is rotated on the rotating table.

5. The method of claim 4, wherein partially dehydrating the edible container upon the mold further comprises releasing the mold from the rotating table.

6. The method of claim 1, wherein dehydrating the edible container upon the mold further comprises placing the mold into a dehydrator for 24 hours between 100 F-115 F, and wherein dehydrating the edible container to a desired moisture content further comprises placing the edible container back into the dehydrator for an additional three hours at the same temperature.

7. The method of claim 1, wherein smoothing the paste comprises smoothing the paste with a spatula.

8. The method of claim 7, wherein the consistent thickness comprises a first thickness in a first part of the edible container, and a second thickness, different from the first thickness, in a second part of the edible container.

9. An edible container, comprising:
a dehydrated paste, further comprising flax seeds, sunflower seeds, celery, carrots, garlic, red tomatoes, red bell peppers, salt, and pepper.

10. The edible container of claim 9, wherein the edible container is a bowl, a cup, or a tray.

11. The edible container of claim 10, wherein the edible container has a wall comprised of the dehydrated paste that is between 2 mm and 4 mm thick.
